(19) United States
(12) Patent Application Publication
(10) Pub. No.: US 2007/0130204 A1
(43) Pub. Date: Jun. 7, 2007

(54) Dynamic electronic rating and ranking system

(75) Inventors: Michael J. Seelig, Berkeley, CA (US); Seth G. Merriman, Walnut Creek, CA (US); Bilal Muzaffar, Dublin, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/297,895

(22) Filed: Dec. 7, 2005

(51) Int. Cl. G06F 17/00

(52) U.S. Cl. 707/104.1

(57) ABSTRACT

A computer rates applicants to different business relationship programs. For an application of a company to a business relationship program, the computer receives a program value, company information values and company sales values, and determines a rating value based thereon. Potentially different rating formulas are associated with the different business relationship programs. The computer may determine the rating value by processing the company information values and the company sales values according to a rating formula associated with the program value.

### FIELD OF THE DISCLOSURE

The present disclosure is generally related to methods and systems for rating companies.

### BACKGROUND

Companies evaluate other companies who wish to do business with them. These evaluations are performed via interviews, written documentation, and/or electronic spreadsheets.

### BRIEF DESCRIPTION OF THE DRAWINGS

FIG. 1 is a block diagram of an embodiment of a system for a company to rate other companies;

FIG. 2 is a block diagram of data structures that may be used to store the ratings formulas; and

FIG. 3 is a block diagram of an illustrative embodiment of a general computer system.

### DETAILED DESCRIPTION OF THE DRAWINGS

Disclosed herein are embodiments of an electronic rating tool that dynamically calculates rating values for companies who wish to apply to any of a plurality of different business relationship programs. The rating value, which may be in the form of a priority score and/or a ranking, for each company is based on which of a plurality of different business relationship programs that the company has applied to join. Examples of the business relationship programs include, but are not limited to, one or more sales programs, one or more supplier programs, one or more distributor programs, one or more alliance programs, one or more affiliate programs, and one or more referral programs. The tool manages a different set of scoring criteria and values for each business relationship program.

Automating the initial evaluation process in this manner saves time and money by eliminating those applicants that are deemed not to qualify and prioritizing the remaining applicants. The tool can be extended to multiple internal and/or external corporate systems to use in multiple departments to support all business-to-business programs. The tool can be customized to establish unique, program-specific business rules, criteria and scoring. The tool can be implemented as a Web service computer system.

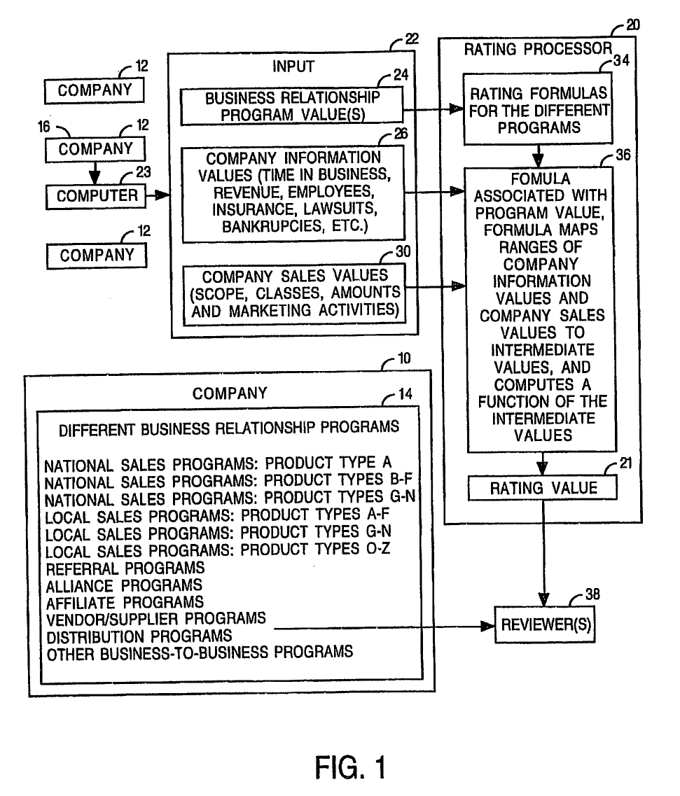

FIG. 1 is a block diagram of an embodiment of a system for a company 10 to rate other companies 12. The other companies 12 wish to have a business relationship with the company 10 via one or more of a plurality of different business relationship programs 14 provided by the company 10. The different business relationship programs 14 may include one or more national business relationship programs and one or more local business relationship programs. The local business relationship programs are commonly divided by state, city, region or market territory. The national business relationship programs may comprise any combination of a national retail program, a national dealer program and a national distributor program. The local business relationship programs may comprise different regional authorized sales programs, each for a different region (e.g. east, midwest, southwest and west).

Examples of the different business relationship programs 14 include, but are not limited to, national sales programs, local sales programs, affiliate programs, referral programs, alliance programs, vendor programs, supplier programs, distributor programs and business-to-business programs. The supplier, vendor and distribution programs may be segmented by region, product type(s), service type(s), material type(s), quality grades, or other criteria. Specific examples of the different business relationship programs 14 include, but are not limited to, a national retail program, a national dealer program, a national distributor program, a value-added reseller program, a premium Web partner program, an affiliate Web partner program, a partner referral program, an alliance partner program, an authorized sales agents program, an authorized distributor program, an enterprise solution provider program, and authorized sales representative programs.

The system comprises a rating processor 20 that calculates or otherwise determines rating values for the other companies 12. Although any number of other companies 12 may be rated using the system, the following description is made with reference to rating a company 16.

The rating processor 20 determines a rating value 21 for the company 16 based on received input 22 associated with the company 16. The received input 22 comprises a program value 24, company information values 26 and company sales values 30 for the company 16 to be rated.

The input 22 may be received via an online, electronic application form to apply for a business relationship with the company 10. The form may be accessible via a Web site of the company 10 or via internally-supported computer software. The PRM Web site may provide other PRM tools. The input 22 may be entered by a member of the company 16 using a computer 23.

The program value 24 indicates which of the different business relationship programs 14 that the company 16 has applied. In general, each of the other companies 12 may apply for one or more of the different business relationship programs 14.

The company information values 26 indicate general information about the company 16 to be rated. Examples of the company information values 26 include, but are not limited to, an amount of time in business (e.g. a number of years in business), an annual revenue (e.g. measured in dollars or another currency), a number of employees, an amount of liability insurance (e.g. measured in dollars or another currency), a lawsuit indication (e.g. yes or no), a bankruptcy filing indication (e.g. yes or no), a number of service types offered (e.g. business consulting, technology consulting, hardware/software installation, etc.), a number of material types sold (e.g. steel, iron, rubber, wood, plastic, glass, etc.), and a quality grade (e.g. an industry quality rating, a capability maturity model level, an ISO standard, etc.).

The company sales values 30 indicate a scope of sales, classes of sales, amounts of sales, and marketing activities for the company 16 to be rated. As used herein, sales may be indicative of actual sales or projected sales.

The scope of sales may be represented by a value that indicates how many states, provinces, countries, or other geographical regions that the company 16 has sales. The classes of sales may be represented by one or more values that indicate whether the company 16 has business sales, residential sales or both. The amount of sales indicates an amount of sales either in units, customers, dollars or another currency. The marketing activities may be represented by a value that indicates a number of marketing activities for the company 16. The marketing activities may be based on a business plan and/or distribution capabilities of the company 16.

Examples of amount-of-sales values include, but are not limited to, a first value indicating an amount of voice telephony sales, a second value indicating an amount of wireless telephony sales, a third value indicating an amount of Internet service provider (ISP) sales (e.g. an amount of digital subscriber line sales or dial-up service sales), a fourth value indicating an amount of wireless Internet access sales, a fifth value indicating an amount of video services sales, a sixth value indicating an amount of managed services solutions sales (e.g. SBC PremierSERV^{SM} services), a seventh value indicating an amount of Web hosting sales, an eighth value indicating an amount of teleconferencing sales (e.g. audio/video/Web conferencing sales), a ninth value indicating an amount of directory sales (e.g. White Pages and Yellow Pages sales), and a tenth value indicating an amount of equipment sales (e.g. voice or video equipment sales). Any number of different product types can be represented by amount-of-sales values.

Optionally, if a state or region is selected outside a territory served by the company 10, another program (e.g. a national program) may need to be selected before submitting the application. The need to select another program is enforced by one or more business rules defined by the company 10.

The rating processor 20 can determine the rating value 21 for the company 16 based on the program value 24, the company information values 26 and the company sales values 30 in a variety of ways. In an embodiment, the rating processor 20 associates potentially different rating formulas 34 with the different business relationship programs 14. The rating processor 20 processes the company information values 26 and the company sales values 30 using a particular rating formula 36 associated with the program value 24.

Each rating formula may map ranges of company information values 26 and company sales values 30 to intermediate values. Each of the ranges may be defined by a corresponding start range and/or a corresponding end range. Each rating formula assigns a corresponding score value to each of the ranges. If an input value is within a particular range defined by the formula, the score value that the formula has assigned to the particular range is used as an intermediate value.

The intermediate values for all of the input values are processed to determine the rating score. The intermediate values may be summed (either weighted or unweighted), averaged, or computed using another function to determine the overall rating score. In an embodiment, the intermediate values represent points that are summed to obtain an overall rating score, where higher point values are indicative of a better rating score.

An embodiment of a mapping of the amount of time in business to an intermediate value is as follows. If the company has been in business for less than 2 years, the intermediate value is 0. If the company has been in business for 3 to 5 years, the intermediate value is 2. If the company has been in business for 6 to 10 years, the intermediate value is 4. If the company has been in business for over 10 years, the intermediate value is 5.

An embodiment of a mapping of the annual revenue to an intermediate value is as follows. If the company has an annual revenue of less than $1 million, the intermediate value is 1. If the company has an annual revenue of between $1 million to $100 million, the intermediate value is 2. If the company has an annual revenue of between $101 million to $500 million, the intermediate value is 4. If the company has an annual revenue of $501 million or greater, the intermediate value is 5.

An embodiment of a mapping of the number of employees to an intermediate value is as follows. If the company has 25 or less employees, the intermediate value is 0. If the company has between 26 to 100 employees, the intermediate value is 2. If the company has between 101 to 300 employees, the intermediate value is 3. If the company has 301 or more employees, the intermediate value is 4.

An embodiment of a mapping of the amount of liability insurance to an intermediate value is as follows. If the company has $500 k or less in liability insurance, the intermediate value is 0. If the company has between $501 k and $1000 k in liability insurance, the intermediate value is 2. If the company has between $1001 k and $3000 k in liability insurance, the intermediate value is 3. If the company has $3001 k or more in liability insurance, the intermediate value is 3.

An embodiment of a mapping of the lawsuit indication to an intermediate value is as follows. If the company is involved in any lawsuits, the intermediate value is −20. If the company is not involved in any lawsuits, the intermediate value is 0.

An embodiment of a mapping of the bankruptcy filing indication to an intermediate value is as follows. If the company has any bankruptcy filings, the intermediate value is −25. If the company does not have any bankruptcy filings, the intermediate value is 0.

An embodiment of a mapping of the scope of sales to an intermediate value is as follows. If the company has sales in 1 state, the intermediate value is 1. If the company has sales in 2 to 4 states, the intermediate value is 2. If the company has sales in 5 to 8 states, the intermediate value is 3. If the company has sales in 9 or more states, the intermediate value is 4.

An embodiment of a mapping from a services value to an intermediate value is as follows. If the company offers only business services, the intermediate value is 2. If the company offers only residential services, the intermediate value is 3. If the company offers both residential and business services, the intermediate value is 4.

A mapping for any of the amount-of-sales values to an intermediate value is as follows. If the amount-of-sales value is less than 25, the intermediate value is 5. If the amount-of-sales value is from 26to 50, the intermediate value is 7. If the amount-of-sales value is from 51 to 75, the intermediate value is 10. If the amount-of-sales value is from 76 to 100, the intermediate value is 12. If the amount-of-sales value is from 101 to 500, the intermediate value is 15. If the amount-of-sales value is from 501 to 1000, the intermediate value is 20. If the amount-of-sales value is more than 1000, the intermediate value is 25.

An embodiment of a mapping from a number-of-marketing-activities value to an intermediate value is as follows. If the company has no marketing activities, the intermediate value is 0. If the company has 1 marketing activity, the intermediate value is 1. If the company has from 2 to 4 marketing activities, the intermediate value is 2. If the company has from 5 to 8 marketing activities, the intermediate value is 4. If the company has 9 or more marketing activities, the intermediate value is 5.

Some business relationship programs may sum all of the above intermediate values, using a single point value for each input value, to determine the rating value. For example, a national retail program, a national distributor program, a premium Web partner program, a partner referral program, an alliance partner program and a national authorized sales agents program may use all of the above intermediate values, though each may have its own unique mappings.

Other business relationship programs may sum fewer than all of the above intermediate values to determine the rating value. For example, a national dealer program and a value-added reseller program may exclude an intermediate value for the class of services. As another example, a regional authorized distributor program, a regional enterprise solution provider program and a regional authorized sales representative program may exclude intermediate values for the class of service and the number of states.

In general, any of the national sales programs, local sales programs, distributor programs, referral programs, alliance programs, and vendor programs can have its own unique mapping and can use either all or fewer than all of the intermediate values to determine the rating value.

The affiliate Web partner program may be excluded from using the online application, and thus may not use any of the above intermediate values as described above. Companies applying for the affiliate Web partner program may be redirected to another Web site for completing a separate online application managed by another entity.

The rating processor 20 outputs the rating value 21 for the company 16 (and optionally rating values for other applicants) in either a hard copy (e.g. using a printer) or a soft copy (e.g. using a display device) format. The rating processor 20 can sort the applicants, from best-to-worst, based on their rating values. The applicants can be sorted within each business relationship program. By sorting or otherwise prioritizing the applicants based on their rating values, better applicants can be approved for the business relationship programs, which can lead to increased profitability by decreasing recurring business-to-business manual evaluation costs and increasing overall revenue for the company.

The rating values for applicants of a business relationship program can be outputted to one or more reviewers 38 of the company 10. The reviewer(s) 38 may comprise one or more consumer prospect reviewers and/or one or more business prospect reviewers who determine whether or not to approve program applications. Each business relationship program may have its own set of one or more reviewers. Names and contact information (e.g. e-mail addresses or phone numbers) of the reviewers for a business relationship program may be stored in a database.

The reviewers or a program manager assigned to a business relationship program may have the authority to modify parameters of its rating formula. The rating processor 20 can receive, as an input, modified parameter values from a reviewer or a program manager of a particular business relationship program. The rating processor 20 stores and uses the modified parameter values when subsequently determining rating values for the particular business relationship program. In this way, the rating formulas can evolve over time. Further, each rating formula can better reflect the importance of each of the input values to its particular business relationship program. Still further, different formulas can be used for the same type of business relationship program but for different regions.

Another dynamic aspect is that each of a plurality of sales programs can have a respective combination of product types that is dynamically defined by the company 10. As product mixes change over time, any combination of the particular inputs required from applicants, the rating formulas and/or the rating values can change accordingly. In general, the product types reflected in the company sales values 30 can be dynamically added, deleted, changed and/or expanded to any number to support marketing objectives of the company 10.

Yet another dynamic aspect of the calculation of the rating values is that if the company information values and the company sales values are updated, an updated rating value is determined for the applicant immediately after the updates are made by a user.

If a company applies for multiple programs on a single application, the rating processor 20 may determine multiple rating values for the multiple programs, and average the multiple rating values. For example, the company 16 may apply for both a first business relationship program and a second business relationship program. In this case, the rating processor 20 determines: a first rating value based on a first program value, the company information values and the company sales values; and a second rating value based on a second program value, the company information values and the company sales values. The first program value identifies the first program's business rules, start and end ranges, direct criteria and individual scores to assign for each range of input value. These values are used to process the company information values and the company sales values to determine the first rating value. The second program value identifies the second program's business rules, start and end ranges, direct criteria and individual scores to assign for each range of input value. These values are used to process the company information values and the company sales values to determine the second rating value.

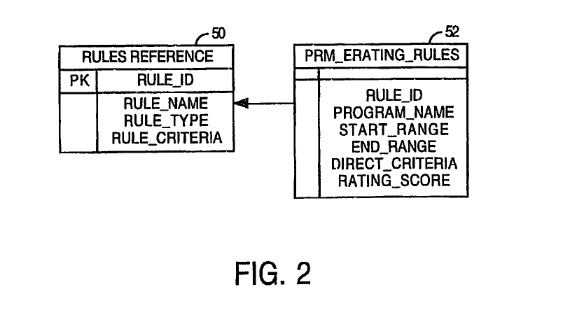

FIG. 2 is a block diagram of data structures that may be used to store the ratings formulas. A rules reference data structure 50 has a rule identifier as a primary key. Associated with each rule identifier are a rule name, a rule type, and rule criteria. An e-rating rules data structure 52 associates each rule identifier with a program name to indicate its associated business relationship program, a start range, an end range, direct criteria, and a rating score.

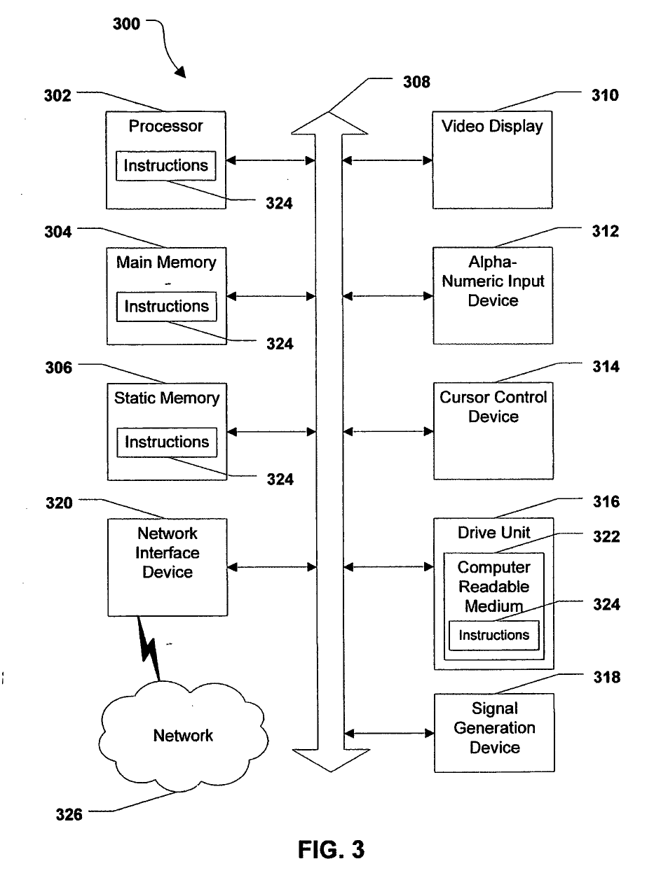

Referring to FIG. 3, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
providing a plurality of different business relationship programs;
receiving a first program value indicating a first business relationship program for which a company has applied, the first business relationship program being one of the plurality of different business relationship programs;
receiving a plurality of company information values and a plurality of company sales values for the company; and
determining, using a computer, a first rating value for the company based on the first program value, the plurality of company information values and the plurality of company sales values.

2. The method of claim 1 further comprising:
receiving a second program value indicating a second business relationship program for which the company has applied, the second business relationship program being another one of the plurality of different business relationship programs; and
determining, using the computer, a second rating value for the company based on the second program value, the plurality of company information values and the plurality of company sales values.

3. The method of claim 1 further comprising:
associating a plurality of rating formulas with the plurality of different business relationship programs;
wherein said determining the first rating value comprises processing the plurality of company information values and the plurality of company sales values according to a first rating formula associated with the first business relationship program.

4. The method of claim 3 wherein the first rating formula maps ranges of company information values and company sales values to intermediate values that are processed to determine the first rating value.

5. The method of claim 1 wherein the plurality of different business relationship programs comprises a plurality of national programs and a plurality of local programs.

6. The method of claim 5 wherein the plurality of national programs comprises a national retail program, a national dealer program and a national distributor program.

7. The method of claim 5 wherein the plurality of local programs comprises a plurality of regional authorized sales programs.

8. The method of claim 1 wherein the plurality of different business relationship programs comprises a national retail program, a national dealer program, a national distributor program, a value-added reseller program, a premium Web partner program, an affiliate Web partner program, a partner referral program, an alliance partner program, an authorized sales agents program, an authorized distributor program, an enterprise solution provider program, and an authorized sales representative program.

9. The method of claim 1 wherein the plurality of company information values comprises an amount of time in business, an annual revenue, a number of employees, an amount of liability insurance, a lawsuit indication, and a bankruptcy filing indication.

10. The method of claim 1 wherein the plurality of company sales values comprises a first value indicating an amount of voice telephony sales, a second value indicating an amount of wireless telephony sales, and a third value indicating an amount of Internet service provider (ISP) sales.

11. The method of claim 10 wherein the amount of ISP sales comprises an amount of digital subscriber line sales.

12. The method of claim 10 wherein the plurality of company sales values further comprises a fourth value indicating an amount of wireless Internet access sales, a fifth value indicating an amount of video services sales, a sixth value indicating an amount of managed services solutions sales, a seventh value indicating an amount of Web hosting sales, an eighth value indicating an amount of teleconferencing sales, a ninth value indicating an amount of directory sales, a tenth value indicating an amount of equipment sales, and an eleventh value indicating a number of marketing activities.

13. The method of claim 1 further comprising:
updating the plurality of company information values and the plurality of company sales values for the company; and
updating the first rating value for the company based on the first program value, the plurality of company information values and the plurality of company sales values.

14. The method of claim 1 wherein the company information values are based on one or more service types offered by the company, one or more material types sold by the company, and a quality grade associated with the company.

15. The method of claim 1 wherein the plurality of different business relationship programs comprises a plurality of sales programs each of which having a respective combination of product types that is dynamically defined by a hosting company that provides the plurality of different business relationship programs.

16. The method of claim 1 wherein the plurality of different business relationship programs comprises one or more national sales programs, one or more local sales programs, one or more affiliate programs, one or more referral programs, one or more alliance programs, one or more distributor programs, one or more vendor programs, and one or more business-to-business programs.

17. The method of claim 1 further comprising:
using the computer to output the first rating value.

18. A computer-readable medium having computer-readable program code to cause a computer to:
receive a first program value indicating a first business relationship program for which a company has applied, the first business relationship program being one of a plurality of different business relationship programs;
receive a plurality of company information values and a plurality of company sales values for the company; and
determine a first rating value for the company based on the first program value, the plurality of company information values and the plurality of company sales values.

19. The computer-readable medium of claim 18 wherein the computer program code further causes the computer to:
receive a second program value indicating a second business relationship program for which the company has applied, the second business relationship program being another one of the plurality of different business relationship programs; and
determine a second rating value for the company based on the second program value, the plurality of company information values and the plurality of company sales values.

20. The computer-readable medium of claim 18 wherein the computer program code further causes the computer to:
associate a plurality of rating formulas with the plurality of different business relationship programs;
wherein the first rating value is determined by processing the plurality of company information values and the plurality of company sales values according to a first rating formula associated with the first business relationship program.

21. The computer-readable medium of claim 20 wherein the first rating formula maps ranges of company information values and company sales values to intermediate values that are processed to determine the first rating value.

22. The computer-readable medium of claim 18 wherein the plurality of different business relationship programs comprises a plurality of national programs and a plurality of local programs.

23. The computer-readable medium of claim 22 wherein the plurality of national programs comprises a national retail program, a national dealer program and a national distributor program.

24. The computer-readable medium of claim 22 wherein the plurality of regional programs comprises a plurality of regional authorized sales programs.

25. The computer-readable medium of claim 18 wherein the plurality of different business relationship programs comprises a national retail program, a national dealer program, a national distributor program, a value-added reseller program, a premium Web partner program, an affiliate Web partner program, a partner referral program, an alliance partner program, an authorized sales agents program, an authorized distributor program, an enterprise solution provider program, and an authorized sales representative program.

26. The computer-readable medium of claim 18 wherein the plurality of company information values comprises an amount of time in business, an annual revenue, a number of employees, an amount of liability insurance, a lawsuit indication, and a bankruptcy filing indication.

27. The computer-readable medium of claim 18 wherein the plurality of company sales values comprises a first value indicating an amount of voice telephony sales, a second value indicating an amount of wireless telephony sales, and a third value indicating an amount of Internet service provider (ISP) sales.

28. The computer-readable medium of claim 27 wherein the amount of ISP sales comprises an amount of digital subscriber line sales.

29. The computer-readable medium of claim 27 wherein the plurality of company sales values further comprises a fourth value indicating an amount of wireless Internet access sales, a fifth value indicating an amount of video services sales, a sixth value indicating an amount of managed services solutions sales, a seventh value indicating an amount of Web hosting sales, an eighth value indicating an amount of teleconferencing sales, a ninth value indicating an amount of directory sales, a tenth value indicating an amount of equipment sales, and an eleventh value indicating a number of marketing activities.

30. The computer-readable medium of claim 18 wherein the computer program code further causes the computer to:
update the plurality of company information values and the plurality of company sales values for the company; and
update the first rating value for the company based on the first program value, the plurality of company information values and the plurality of company sales values.

31. The computer-readable medium of claim 18 wherein the company information values are based on one or more service types offered by the company, one or more material types sold by the company, and a quality grade associated with the company.

32. The computer-readable medium of claim 18 wherein the plurality of different business relationship programs comprises a plurality of sales programs each of which having a respective combination of product types that is dynamically defined by a hosting company that provides the plurality of different business relationship programs.

33. The computer-readable medium of claim 18 wherein the plurality of different business relationship programs comprises one or more national sales programs, one or more local sales programs, one or more affiliate programs, one or more referral programs, one or more alliance programs, one or more distributor programs, one or more vendor programs, and one or more business-to-business programs.

34. An apparatus comprising:
a computer to:
receive a first program value indicating a first business relationship program for which a company has applied, the first business relationship program being one of a plurality of different business relationship programs;
receive a plurality of company information values and a plurality of company sales values for the company; and
determine a first rating value for the company based on the first program value, the plurality of company information values and the plurality of company sales values.
